(19) United States
(12) Patent Application Publication
(10) Pub. No.: US 2016/0066153 A1
(43) Pub. Date: Mar. 3, 2016

(54) SYSTEM AND METHOD FOR FACILITATING AD HOC PEOPLE GATHERINGS

(71) Applicant: APPROACH ME, INC, Santa Clara, CA (US)

(72) Inventor: Tariq Tony GHANMA, Santa Clara, CA (US)

(21) Appl. No.: 14/843,950

(22) Filed: Sep. 2, 2015

Related U.S. Application Data
(63) Continuation of application No. 14/582,825, filed on Dec. 24, 2014.
(60) Provisional application No. 62/044,899, filed on Sep. 2, 2014.

(51) Int. Cl. H04W 4/02

(52) U.S. Cl. CPC H04W 4/025; H04W 84/18

(57) ABSTRACT

A method for facilitating an ad hoc meeting is provided. The method comprises establishing the ad hoc meeting by a creator, wherein said creator establishes a location for the ad hoc meeting, and at least one invitee to the ad hoc meeting; notifying each invitee of the ad hoc meeting; receiving location and directional information for the creator and each invitee; calculating a relative distance and a relative direction between the creator and each invitee; and causing a radar screen to be displayed on a mobile device of the creator; wherein said radar screen is configured to show a location of the creator at the center, and a current position and direction for each invitee relative to the creator.

This application claims the benefit of priority to U.S. Provisional Patent Application No. 62/044,899 entitled “SYSTEM AND METHOD FOR FACILITATING AD HOC PEOPLE GATHERINGS”, which was filed on Sep. 2, 2014.

This application is also a continuation of U.S. patent application Ser. No. 14/582,825 Entitled “SYSTEM AND METHOD FOR A CAB DRIVER TO LOCATE A PERSON”, which was filed on 24 Dec. 2014, and which is incorporated herein by reference in its entirety.

### FIELD AND BACKGROUND

The inventor has found that there are various social situations or scenarios in which there is a need for people to locate each other. For example, at a concert, park, or sports event it is often difficult to locate friends. In such situations people resort to text messages and/or phone calls to locate each other.

### SUMMARY

A method for facilitating an ad hoc meeting is provided. The method comprises establishing the ad hoc meeting by a creator, wherein said creator establishes a location for the ad hoc meeting, and at least one invitee to the ad hoc meeting; notifying each invitee of the ad hoc meeting; receiving location and directional information for the creator and each invitee; calculating a relative distance and a relative direction between the creator and each invitee; and causing a radar screen, to be displayed on a mobile device of the creator; wherein said radar screen is configured to show a location of the creator at the center, and a current position and direction for each invitee relative to the creator.

Other aspects of the invention will be apparent from the detailed description that follows.

### BRIEF DESCRIPTION OF THE DRAWINGS

FIG. 1 of, there is shown a deployment scenario 100 for the ApproachMe Service, in accordance with one embodiment

FIG. 2 shows an example of a UI for creating a new meetup spot, in accordance with one embodiment.

FIGS. 3 and 6 show examples of a radar, in accordance with one embodiment.

FIG. 4 shows a listing of meetup spots for a creator, in accordance with one embodiment.

FIG. 5 shows a sample navigation structure for the ACA 108, in accordance with one embodiment.

### DETAILED DESCRIPTION OF SOME EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring, to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a service referred to herein as the “ApproachMe Service” for descriptive convenience. The ApproachMe Service may be used to locate people in various contexts such as at a ball game, at a theme park, at a concert, etc.

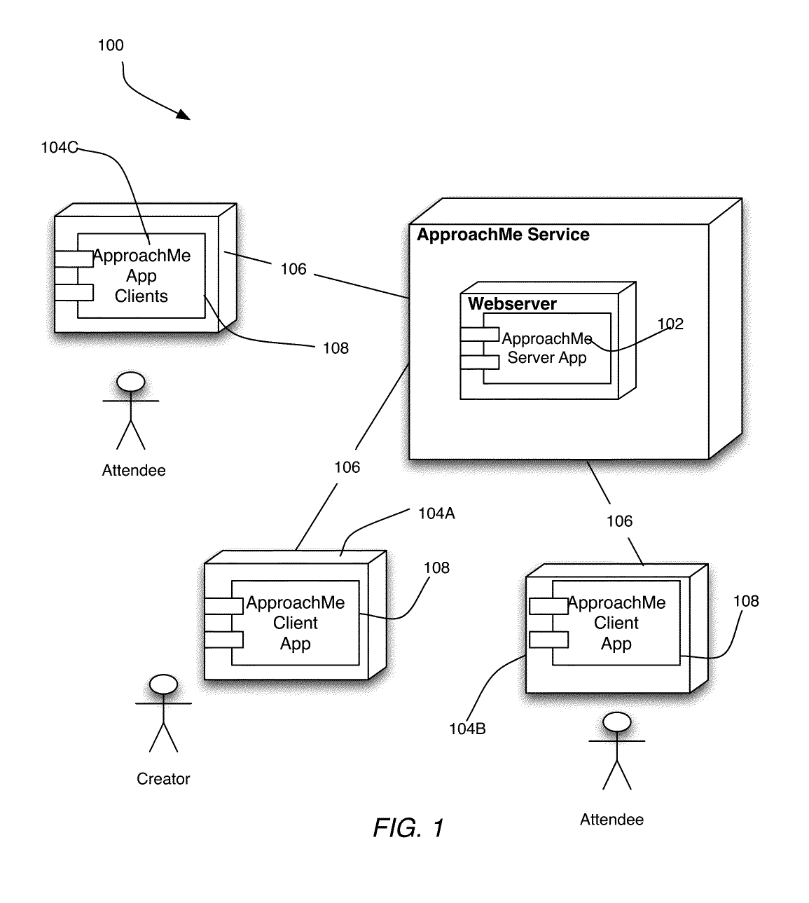

Turning now to FIG. 1 of the drawings, there is shown a deployment scenario 100 for the ApproachMe Service, in accordance with one embodiment. As will be seen, the deployment scenario 100 includes an ApproachMe Serer App (ASA) 102 which may be deployed in the cloud on a single server or across multiple servers and locations. In use, the ASA 102 may be communicatively coupled to a plurality of client devices 104A . . . 104N via communications links 106. Said communications links may support wireless voice and data communications. In one embodiment, the client devices may represent mobile devices such as smartphones. Each client device 104A . . . 104N may be provisioned with an ApproachMe Client App (ACA) 108. The ASA 102 and the ACA 108 may be configured to implement various aspects of the ApproachMe service, which will now be described with reference to the following terms:

Radar: a screen with a set range that tracks both the user and his or her guests using combined location and compass data to accurately and in real-time track the location and movement of guests.

Radar range: defines as range within which tracking is effective using the radar. The radar range may be set by the user or the program (ACA 108). In one embodiment, the default radar range is set to 150 ft approx. 50 meters.

Creator: refers to the creator of an event or a meeting spot for others to locate.

Sub-creator: These are guests of the creator who choose to invite other guests to the meeting spot created originally by the creator.

Attendee: These are people who attend an event of the creator, but do not in turn invite others.

Advantageously, in one embodiment the ApproachMe service may be used to accurately locate people, within walking distances, in a crowded area by providing a real location of the person regardless if that person is stationary or moving. For example, the ACA 108 may be used to activate a radar display on the client device of a first person on which the location of a second person is shown.

The ApproachMe Service does not require meeting at a predefined location on a map. Moreover, the meeting location might not be permanent/persistent location. An example of the latter would be an ad hoc meeting, say at a park, or an ad hoc meeting corresponding to the location of a mobile of vendor, such as a food truck. Instead, with the ApproachMe Service, a Creator may create a named event that does not have to have a physical address. Each Creator is treated as the center of the event he/she creates. Thus, all invited guests revolve around the Creator.

In one embodiment, the radar range may be set by a user or the ACA 108. By default, the radar range may be set to 150 ft. or approx. 50 meters. This allows a creator the ability to create an ad hoc event, called a meetup spot, and to invite selected guests to join the meet up spot in order to locate each other. The meetup spot can be preset and can have an actual address (i.e. a street address) or it may not have an actual address, in which case it will be identified in terms of a GPS location.

Coincidentally, a meetup spot may be at an address or a location that has augmenting information that can be displayed in association with the meetup spot to facilitate better navigation. For example, the augmenting information may include a map for directions, or a map of features and promotions, or specific events and gatherings, or any other like graphical information that is useful in the context of facilitating a meeting of people. Thus, in some embodiments, event maps such as a wedding table map, theme park map, conference center map, shopping mall or any other event or location may be displayed together with the radar. A user can select an area or simply select to meet up at a certain area, and once others arrive within the radar range the user can then locate them.

In one embodiment, a radar screen may display multiple users and track each of them in real-time. The radar may show walking distances, and direction information to facilitate accurate location of the participants/guests of a meet.

In one embodiment, the radar screen will have an actual unique indicator for each user. The unique indicators allow the various guests to be identified. In one embodiment, the unique indicators for the guests move in real-time on the radar screen to provide insight as to the movement of the guests. The indicators may comprise dots of different colors, icons, a profile photo of a user, words, charms, etc.

In one embodiment, the ACA 108 may be configured to allow users to chat privately or as a group with any member or all members participating in a meet up.

In one embodiment, a creator or a sub-creators may receive an alert once any invited guest is within the radar range.

The radar may be configured to only show the location of users within the radar range. However, any user who accepts an invitation to meet will reveal their geo-location on the ACA 110. The radar will indicate them out, to be “Out of Range”, that would indicate their relative direction on the radar screen of a creator, or sub-creator. The actual map the location of an out of range user will not be shown. This protects the privacy of users even if they are trackable.

Meet up spots may be set up with a set period of time for expiration. For example, a concert can expire in a day. The user also can set up the time interval to “Forever” in the event the want to track custodial users such as children or pets. This allows the non-custodial users not to give up privacy for more than the set period of the event.

An event creator can invite any guest in their contact list. Each invitee can also invite any guest they choose on their contact list to the same meet up spot (sub-creators). However, a sub-creator's guest can only be seen on the radar of the sub-creators and not on the creator's list.

In one embodiment, a fixed sensor that synchronizes to the ACA 108 allows a user to add a specific name to the fixed sensor. The fixed sensor may then be tracked within a spot the user creates. The fixed sensor may be used to track children, pets, and other stationary or moving objects on the radar screen. In on embodiment, each sensor is assured a unique identifier or name by the user. The user then can set up an alert based on user-defined out of range settings. For example, a spot may be defined in terms of a certain GPS location, and out of range settings for this spot may be set to 50 feet. This means that the creator will be alerted if whatever object (example pet or child) the sensor is attached to it, goes more 30 feet from the GPS location of the spot. The out of range parameter is smaller than the radar range. For example, if a child exceeds 50 ft from the user's device, an alert will warn the user and the user then can track the child while still in the radar range.

The embodiment that uses a fixed sensor may be used to implement a form of geo-fencing in which only for invited guests leaving the area defined by the radar range an alert is triggered. Thus, for example kids and pets may be tethered to a creator.

In one embodiment, the radar range may be increased up to few miles based on user preferences.

In one embodiment, an “Out of Range” ring around the radar screen may indicate the current location of the sensor, and the direction relevant to the user being the center of the radar screen.

These fixed sensors may be configured to generate any alert of it is submerged under water. For example, the sensors may be water resistant to survive contact with water but only transmit an alarm signal when submerged. This may, for example, prevent an accidental drowning, but prevent false alarms generated say through a sensor getting wet in the rain.

Once a guest has accepted the invitation to the creator's meet up spot, each guest then can be tracked once they enter the radar range, even if the user's device is in sleep mode.

In one embodiment, the sensors may be RFID sensors and may broadcast their location to RFID readers configured to relay said location information to the ASA 108.

In one deployment scenario for the technology disclosed herein, products may include sensors (such as RFID sensors) so that manufacturer associated with a product can use the ACA 108 or a co-branded licensed version thereof to allow consumers to select and navigate to a seller of the product. Once the consumer is at the seller's location, the ACA 108 may be used by the consumer to find the product's exact location on a shelf by using the radar technology described above. For example, a wine seller can insert a RFID tag into a wine cork. A co-branded ACA 108 will allow a consumer to select and navigate to a nearby seller of the wine, by utilizing direction and distance. Once at the seller's location, the radar of the ACA 108 may be used to locate the exact location of the bottle of wine.

RFID tags and active RFID devices may be used to communicate to the location and distance of kids and pets to the ACA 108 of a client device.

In the case of sports events, and concerts, the ApproachMe Service may allow promoters such as LiveNation to co-brand and skin a website configured to allow customers (fans) to download a co-branded ACA 108 to their devices to locate their friends at concerts and sports events.

If a device does not have either WiFi or cellphone service, the ACA 108 may be configured to alert the user that there is no signal and thus the data is not live. This prevents users from relying on stale location information form the ASA 102.

In cases where the connection to the ASA 102 by a ACA 108 of a user is intermittent, such as in large gathering and concerts, the ApproachMe Service may be configured to predict the movement of the user. Said prediction may be based on predicting the direction of the movement of the user by simply map the last location to the new location once broadcasted and using timing information for the user.

In one embodiment, to minimize the battery drainage and the heat up of a client device the ACA 108 may be configured to monitor the movement of a user. If the user remains in the same location the device does not refresh in real time, it locks the location of the user and stops live broadcasting. The ACA 102 locks the location and broadcast it to other users on the radar. However, once the user moves, then the location updates. This halt in continuous broadcasting minimizes heat and usage of the battery.

In one embodiment, any user can notify the ACA 102 of the arrival of a user at a meet up location. For example, a user can perform a simple swipe that indicates that that user has arrived to the location. At that moment, any other user on the radar will be notified of the arrival or can view information indicating that the user has arrived. In one embodiment, a “map it” button may appear next to the user so others can click it and view directions on how to get the meet up location. If the user clicking the button is more than a fixed distance away, such as 1000 feet, then a map will appear using the device map, such apple maps, or google maps to show directions. If the user is less than the fixed distance, then the radar appears and shows the direction and location to approach the user.

In situations where a person is need of immediate assistance, the ApproachMe Service may be configured to allow any user on the radar to send an SOS alert to any other guest on the same meetup spot requesting immediate help or assistance for others to approach and find that person. The SOS alert may be pre-programmed or it may be customized. For example, when a guest is at a bar, and they are being harassed by someone, they can simply send an SOS alert to other friends in the same meetup spot to conic to their rescue. The radar technology will assist any other guest on finding exact location of the person sending the SOS. This also can work if someone is stuck someplace and would want assistance to arrive at his or her exact spot.

For SOS alerts, the ACA 108 may be configured to show a feature button or link to send an SOS alert on the radar screen, or to allow a “press and hold” on any guest/user that has joined the meetup spot. Then a set of choices for predefined SOS alerts can be shown and selected or a single SOS may be sent to the guest/user.

In one embodiment, the SOS feature may be combined with the “map it” feature. This embodiment will help locate people no matter where they are. Anyone that accepts an invitation on the meet up spot or the radar can get alerted of the location first by the ability to map the exact location and then once they are close using the radar they can pinpoint exactly where that person in need for help is. Thus, there is no longer a need for address sending and calling and texting.

In one embodiment, when someone is within close range such as 25 feet away, the ASA 108 does not display how many feet away the person is. Instead the ACA may be configured to switch to “you can see me” mode in which alerts the person searching that the person is within the line of sight.

The technology disclosed herein may be used in public place such as in airports for people to find each other and to find gates and other areas.

Each of the functions/features described above may be implemented through the ACA 108 on its own or in combination with the ASA 102 as modules.

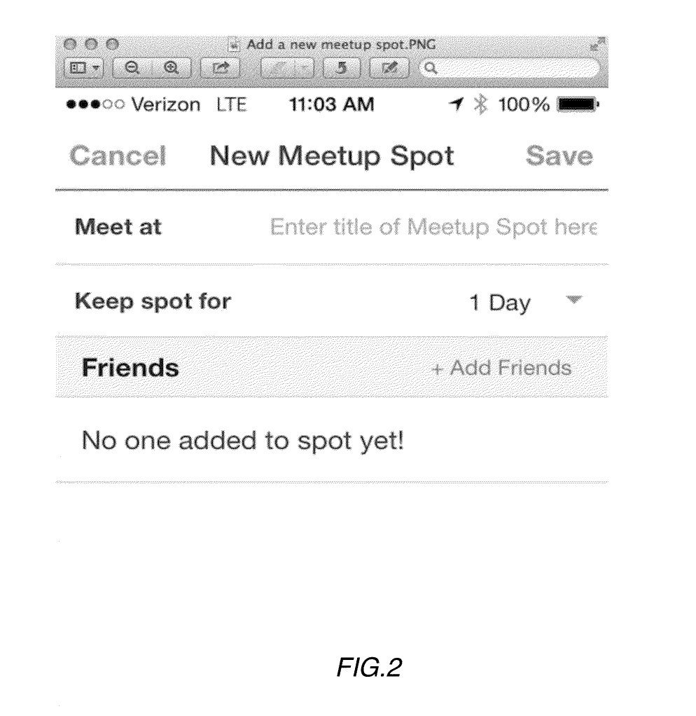

FIG. 2 shows an example of a UI for creating a new meetup spot, in accordance with one embodiment.

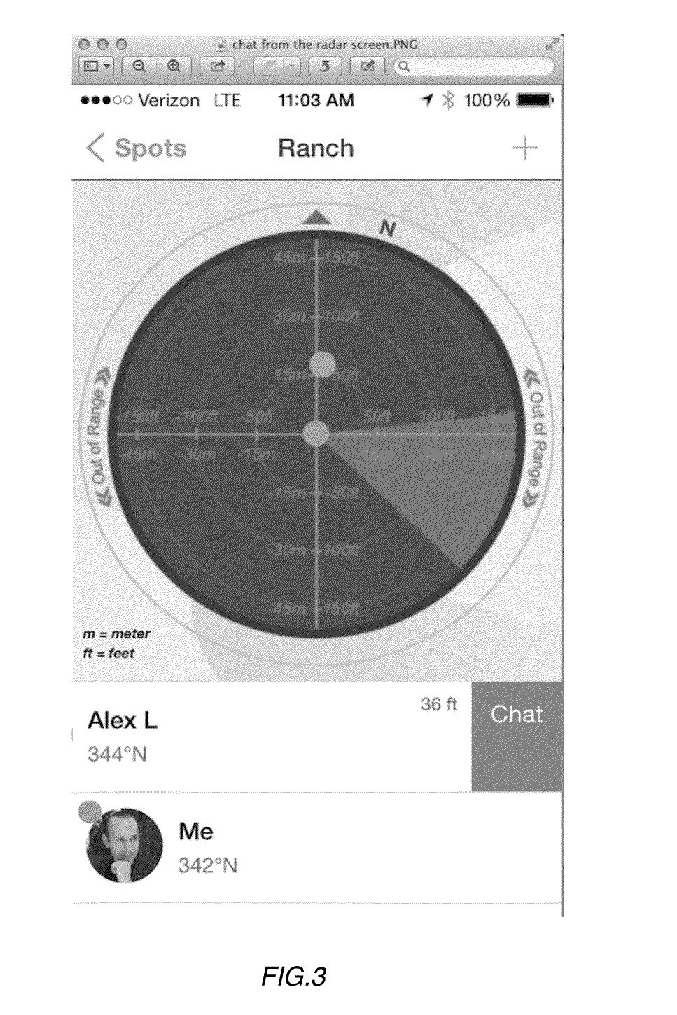

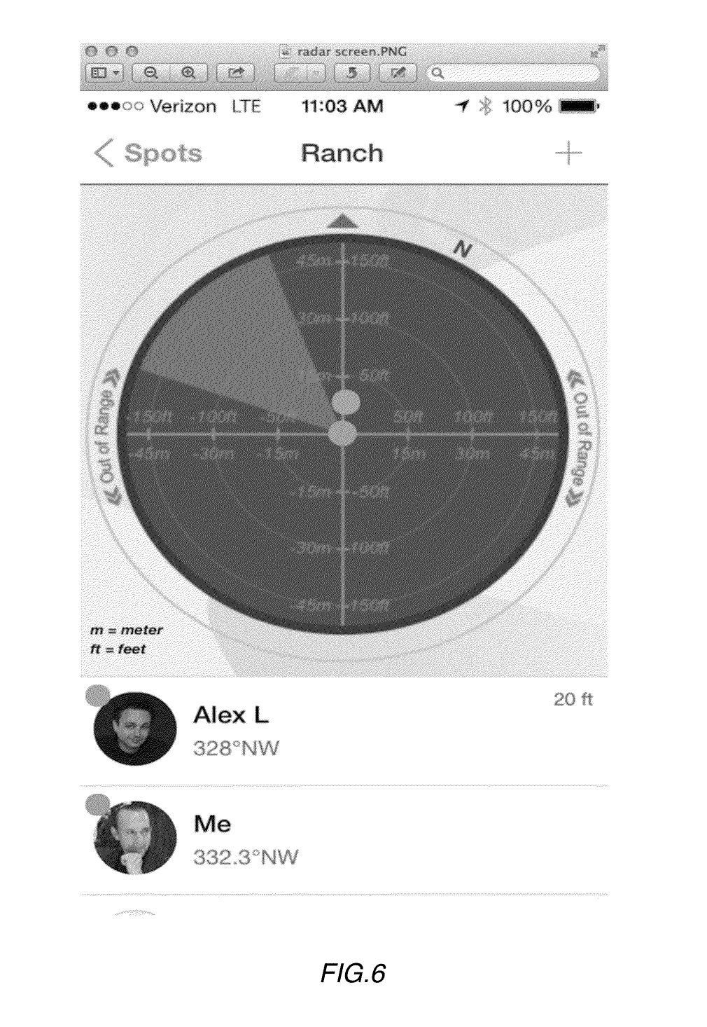

FIGS. 3 and 6 show examples of a radar, in accordance with one embodiment.

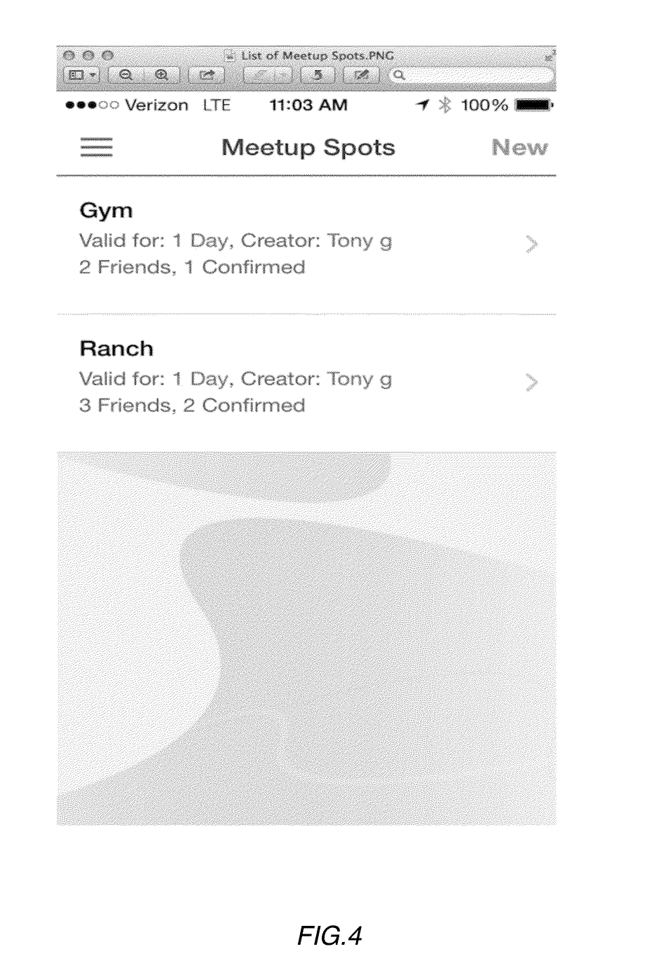

FIG. 4 shows a listing of meetup spots for a creator, in accordance with one embodiment.

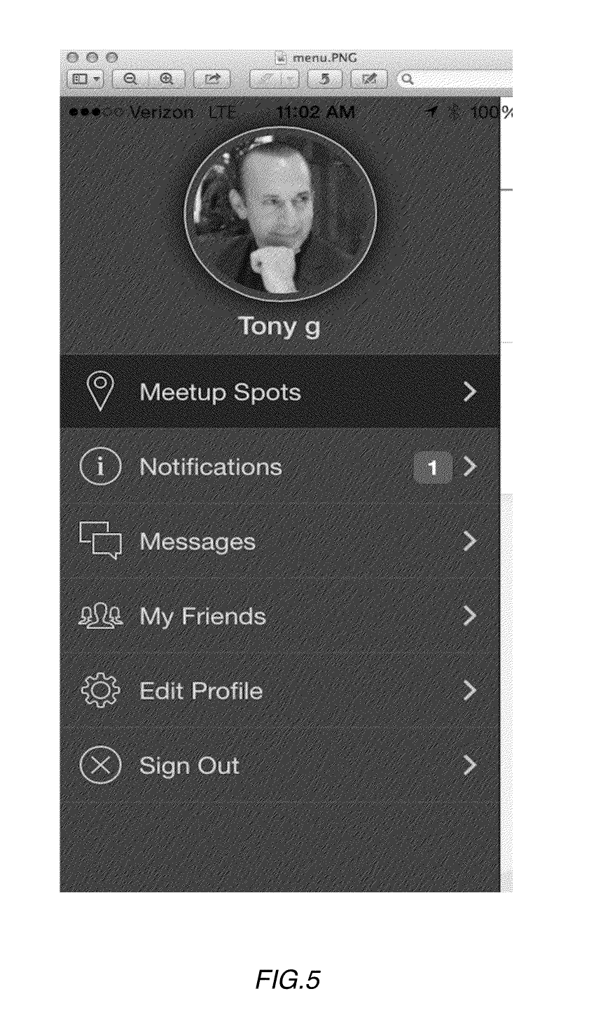

FIG. 5 shows a sample navigation structure for the ACA 108, in accordance with one embodiment.

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules night be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database module might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Although invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for facilitating an ad hoc meeting, comprising:
establishing the ad hoc meeting by a creator, wherein said creator establishes a location for the ad hoc meeting, and at least one invitee to the ad hoc meeting;
notifying each invitee of the ad hoc meeting;
receiving location and directional information for the creator and each invitee;
calculating a relative distance and a relative direction between the creator and each invitee; and
causing a radar screen to be displayed on a mobile device of the creator; wherein said radar screen is configured to show a location of the creator at the center, and a current position and direction for each invitee relative to the creator.
